(19) United States
(12) Patent Application Publication
(10) Pub. No.: US 2015/0009093 A1
(43) Pub. Date: Jan. 8, 2015

(54) ANTENNA APPARATUS AND PORTABLE WIRELESS DEVICE EQUIPPED WITH THE SAME

(71) Applicant: NEC CORPORATION, Tokyo (JP)

(72) Inventor: Toru Taura, Tokyo (JP)

(73) Assignee: NEC CORPORATION, Tokyo (JP)

(21) Appl. No.: 14/376,337

(22) PCT Filed: Mar. 18, 2013
(86) PCT No.: PCT/JP2013/001816

§ 371 Date: Aug. 1, 2014

(30) Foreign Application Priority Data
Mar. 28, 2012 (JP) 2012-073664

(51) Int. Cl. H01Q 1/52; H01Q 5/00

(52) U.S. Cl. CPC H01Q 1/521; H01Q 5/0034
USPC 343/893

(57) ABSTRACT

The antenna apparatus of the present invention is characterized by including a substrate, a conductor arranged on one of the surfaces of the substrate, two antennas arranged on the substrate, a notch portion formed to the conductor so as to have an open end between two antennas, a stub formed on the other surface of the substrate so as to cross over the notch portion, and a via for electrically connecting the conductor and the stub.

### TECHNICAL FIELD

The present invention relates to an antenna apparatus having a structure to reduce electromagnetic coupling between a plurality of antennas and a portable wireless device equipped with the same. In particular, the present invention relates to an antenna apparatus having a low coupling structure suitable for a small-sized portable wireless device.

### BACKGROUND ART

In recent years, a miniaturized antenna used for the portable wireless device such as a portable telephone, a smart phone, or the like is developed. Further, with the development of various wireless communication methods, a plurality of antennas are required to be mounted on one portable type wireless device.

Accordingly, in order to mount a plurality of antennas on one portable type wireless device, a technology for reducing a coupling factor between the antennas is developed.

In patent document 1, as shown in FIG. 10, a small integrally formed flat-plate multi-element antenna which can reduce the coupling factor between the antennas by forming a notch portion in a ground pattern is disclosed.

The integrally formed flat-plate multi-element antenna disclosed in patent document 1 includes a ground pattern 2 including a notch portion 2b and a first radiating element 3 and a second radiating element 4 that are symmetrically arranged with respect to the notch portion 2b. The first and second radiating elements 3 and 4 are arranged so that a distance between a position 3a and a position 3b at which a maximum radiation electric field can be obtained is maximum.

In the integrally formed flat-plate multi-element antenna 1 disclosed in patent document 1, by adjusting the length of the notch portion so that the impedance of an open end of the notch portion 2b becomes high in an antenna operating frequency band, an antenna current flowing in the ground pattern 2 is cut off and the electromagnetic coupling between the antennas is reduced. The length of the notch portion between the antennas needs to be approximately equal to one-quarter wavelength of a frequency used by the antenna. For example, when the frequency used by the antenna is 800 MHz, the length of the notch portion is about 90 mm.

Further, in the integrally formed flat-plate multi-element antenna 1 disclosed in patent document 1, when a capacitor is arranged at the open end of the notch portion 2b, a size of the notch portion can be reduced.

Further, in patent document 2, as shown in FIG. 11, an antenna apparatus 5 in which a stub is provided instead of the notch portion and whereby, the coupling factor between the antennas can be decreased is disclosed.

The antenna apparatus 5 disclosed in patent document 2 includes a substrate 6 made of dielectrics, a copper layer 7 formed on one of the surfaces of the substrate 6, a first antenna element 8a and a second antenna element 8b provided as two antenna elements, and a first stub 9a and a second stub 9b provided as two stubs. Two stubs are conductive wiring patterns having a meandering shape and operate as a distributed constant line in a high-frequency range.

In the antenna apparatus 5 disclosed in patent document 2, by reducing the width of the stub, the stub length can be made long without increasing an area of the stub. Therefore, a capacitance can be increased without increasing the area of the stub.

### PRIOR ART DOCUMENT

### Patent Document

[Patent document 1] Japanese Patent Application Laid-Open No. 2007-13643

[Patent document 2] Japanese Patent Application Laid-Open No. 2011-176560

### BRIEF SUMMARY OF THE INVENTION

### Problems to be Solved by the Invention

In the integrally formed flat-plate multi-element antenna disclosed in patent document 1, in order to reduce the coupling factor between the antennas, the length of the notch portion has to be increased. For this reason, when this antenna is used for a portable wireless device in which a mounting space is severely limited, a problem in which the size of the notch portion is too large in a frequency band used by the antenna occurs.

When the capacitor is arranged at the notch portion in order to add a capacitance, when a small capacitor such as a chip capacitor is used, a problem in which the coupling factor between the antennas varies due to the variation in the capacitance value of the chip capacitor occurs. In the antenna apparatus disclosed in patent document 2, because the stub has to be formed on the surface on which the copper layer is formed, when the area for mounting the antenna apparatus is limited, the area for arranging the stub becomes short. By reducing the width of the stub and increasing the length of the stub, the large capacitance can be obtained. However, when the width of the stub is reduced, a problem in which the variation in an isolation characteristic caused by the influence of the shape of the pattern edge becomes large occurs.

An object of the present invention is to provide an antenna apparatus which has a low coupling structure to reduce electromagnetic coupling between a plurality of antennas mounted in a miniaturized portable wireless device, is small, and has a fixed antenna coupling factor.

### Means for Solving the Problems

The antenna apparatus of the present invention includes a substrate, a conductor arranged on one of the surfaces of the substrate, a plurality of antennas arranged on the substrate, a notch portion formed to the conductor so as to have an open end between the plurality of antennas, a stub formed on the other surface of the substrate so as to cross over the notch portion, and a via for electrically connecting the conductor and the stub.

### Effect of the Invention

In the antenna apparatus of the present invention, even when the notch portion is small, an area for arranging the stub can be increased and a large capacitance can be added. Therefore, the size of the antenna apparatus can be reduced.

### BRIEF DESCRIPTION OF THE DRAWINGS

FIG. 1A is a figure showing a face on which a conductor is arranged in an antenna apparatus according to a first exemplary embodiment of the present invention.

FIG. 1B is a figure showing a face on which a stub is arranged in an antenna apparatus according to a first exemplary embodiment of the present invention.

FIG. 1C is a cross section along a line A-A′ of an antenna apparatus shown in FIG. 1A according to a first exemplary embodiment of the present invention.

FIG. 2 is a figure showing a result of simulation of an antenna impedance characteristic of an antenna apparatus according to a first exemplary embodiment of the present invention.

FIG. 3A is a figure showing a face on which a conductor is arranged in an antenna apparatus according to a second exemplary embodiment of the present invention.

FIG. 3B is a figure showing a face on which a stub is arranged in an antenna apparatus according to a second exemplary embodiment of the present invention.

FIG. 3C is a cross section along a line B-B′ of an antenna apparatus shown in FIG. 3A according to a second exemplary embodiment of the present invention.

FIG. 4A is a figure showing a face on which a conductor is arranged in an antenna apparatus according to a third exemplary embodiment of the present invention.

FIG. 4B is a figure showing a face on which a stub is arranged in an antenna apparatus according to a third exemplary embodiment of the present invention.

FIG. 4C is a cross section along a line C-C′ of an antenna apparatus shown in FIG. 4A according to a third exemplary embodiment of the present invention.

FIG. 5A is a figure showing a face on which a conductor is arranged in an antenna apparatus according to a fourth exemplary embodiment of the present invention.

FIG. 5B is a figure showing a face on which a stub is arranged in an antenna apparatus according to a fourth exemplary embodiment of the present invention.

FIG. 5C is a cross section along a line D-D′ of an antenna apparatus shown in FIG. 5A according to a fourth exemplary embodiment of the present invention.

FIG. 6A is a figure showing a face on which a conductor is arranged in an antenna apparatus according to a fifth exemplary embodiment of the present invention.

FIG. 6B is a figure showing a face on which a stub is arranged in an antenna apparatus according to a fifth exemplary embodiment of the present invention.

FIG. 6C is a cross section along a line E-E′ of an antenna apparatus shown in FIG. 6A according to a fifth exemplary embodiment of the present invention.

FIG. 7A is a figure showing a face on which a conductor is arranged in an antenna apparatus according to a sixth exemplary embodiment of the present invention.

FIG. 7B is a figure showing a face on which a stub is arranged in an antenna apparatus according to a sixth exemplary embodiment of the present invention.

FIG. 7C is a cross section along a line F-F′ of an antenna apparatus shown in FIG. 7A according to a sixth exemplary embodiment of the present invention.

FIG. 8A is a figure showing a face on which a conductor is arranged in an antenna apparatus according to a seventh exemplary embodiment of the present invention.

FIG. 8B is a figure showing a face on which a stub is arranged in an antenna apparatus according to a seventh exemplary embodiment of the present invention.

FIG. 8C is a cross section along a line G-G′ of an antenna apparatus shown in FIG. 8A according to a seventh exemplary embodiment of the present invention.

FIG. 9A is a figure showing a portable wireless device according to an eighth exemplary embodiment of the present invention.

FIG. 9B is a figure showing a portable wireless device according to an eighth exemplary embodiment of the present invention when viewed from a face side opposite to the face side shown in FIG. 9A.

FIG. 10 is a figure showing a structure of an antenna described in patent document 1.

FIG. 11 is a figure showing a structure of an antenna apparatus described in patent document 2.

### MODE FOR CARRYING OUT THE INVENTION

A preferred mode for carrying out the present invention will be described below by using a drawing. However, the following exemplary embodiment is shown as one technically preferred embodiment of the present invention. Therefore, the scope of the invention is not limited to the following exemplary embodiment.

### First Exemplary Embodiment

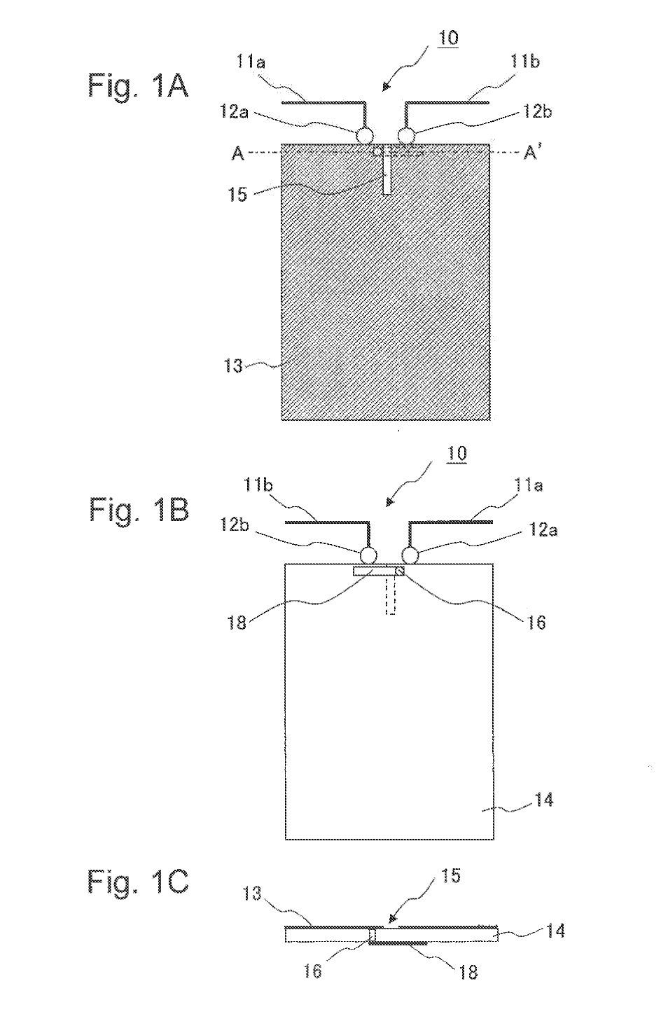

FIG. 1A to FIG. 1C are figures showing an antenna apparatus 10 according to a first exemplary embodiment of the present invention. Further, FIG. 1A shows a surface on which a conductor 13 mentioned later is arranged and FIG. 1B shows a surface on which a stub 18 mentioned later is arranged. FIG. 1C is a cross section along a line A-A′ shown in FIG. 1A.

[Explanation of Structure]

The antenna apparatus 10 according to the first exemplary embodiment of the present invention shown in FIG. 1A to FIG. 1C includes a substrate 14 and the conductor 13 arranged on one of the surfaces of the substrate 14. It is desirable to use a dielectric substrate for the substrate 14. The conductor 13 is made from a material having a good electrical conductivity. For example, a metal material such as copper or the like is suitable. The whole surface of one of the surfaces of the substrate 14 may be covered by the conductor 13 or a part of the surface may not be covered by it. However, because the conductor 13 is used for a ground pattern, it is desirable that the almost whole surface of one of the surfaces of the substrate 14 is covered by the conductor 13. Further, the surface of the substrate 14 on which a notch portion 15 (described later) is formed is not covered by the conductor 13.

Two antennas 11a and 11b are arranged on the substrate 14.

As the antenna, for example, an inverted L shaped antenna or an inverted F shaped antenna can be used. Further, the shape of the antenna can be changed according to the shape or the size of the portable wireless device which mounts the antenna apparatus and the antenna is not limited to the inverted L shaped antenna or the inverted F shaped antenna. The shapes of the antenna 11a and the antenna 11b may not be the same as each other.

In a connection portion for connecting the antennas 11a and 11b and the substrate 14, feeding portions 12a and 12b having a feed point are provided. Further, the shapes of the feeding portion 12a and the feeding portion 12b and the like are not limited in particular.

On the conductor 13, the notch portion 15 having an open end is provided at the end of the conductor 13. The length of the notch portion 15 is set to a length that is shorter than or equal to one-quarter of the wavelength λ of the lowest operating frequency of the antenna apparatus 10. It is desirable that the open end of the notch portion 15 is located at the edge of the substrate 14.

The stub 18 is arranged on the surface opposite to the surface of the substrate 14 on which the notch portion 15 is arranged. The stub 18 according to the first exemplary embodiment is an open stub.

The stub 18 is arranged so as to cross over the notch portion 15. The stub 18 is arranged adjacent to the open end of the notch portion 15. The length L of the stub 18 is set to satisfy L<λ/4.

The stub 18 according to the exemplary embodiment of the present invention is provided on the surface opposite to the surface of the substrate 14 on which the conductor 13 is provided. Further, the stub 18 is arranged so that when the main surface of the substrate 14 is viewed from the upper side thereof in a normal direction, the whole body of the stub 18 is included in an area in which the conductor 13 provided on the rear surface of the substrate 14 exists.

The stub 18 is electrically connected to the conductor 13 by a via 16 that is a through-hole formed in the substrate 14 and has electrical conductivity.

The via 16 according to the exemplary embodiment of the present invention is formed near the between the both end portions of the stub 18 that is close to the open end of the notch portion 15 among the end portions of the stub 18.

Thus, in the antenna apparatus according to the exemplary embodiment of the present invention, the stub and the conductor are provided on the different surfaces. Therefore, the mounting area of the antenna apparatus can be reduced.

[Explanation of Operation]

When the length of the notch portion 15 is set to a length shorter than one-quarter of the wavelength λ in order to reduce the size of the notch portion 15 like this exemplary embodiment, a frequency at which an impedance of the open end of the notch portion 15 becomes high shifts higher than the operating frequency of the antenna apparatus 10. On the other hand, at the operating frequency of the antenna apparatus 10, the impedance of the open end of the notch portion 15 becomes inductive and low. Whereby, the antenna current flows. Therefore, the desired isolation between the antennas cannot be achieved.

As means for making the impedance of the open end high, a method in which a capacitance is added in parallel to the open end and a capacitance value is adjusted so as to generate parallel resonance in the operating frequency band of antenna is used. In the antenna apparatus according to the exemplary embodiment of the present invention, the stub 18 is provided at the open end of the notch portion 15 and the capacitance value is adjusted by tuning the length of the stub 18. It is desirable that the stub 18 is arranged at a position of the notch portion 15 at which the maximum electric field is obtained at the operating frequency of the antenna apparatus 10. The electric field of the notch portion 15 at the antenna operating frequency has the standing wave distribution in which an antinode of the electric field is generated at the open end of the notch portion 15 and a node is generated at a short-circuited end. Therefore, in this case, the most suitable arrangement position of the stub 18 is the open end of the notch portion 15.

In the antenna apparatus 10 according to the exemplary embodiment shown in FIG. 1A to FIG. 1C, the length L of the stub 18 arranged at the open end of the notch portion 15 is set to satisfy L<λ/4 (λ is a wavelength of the operating frequency). This is equivalent to the addition of capacitance to the open end of the notch portion 15. As a result, the isolation frequency of the antenna apparatus 10 which is shifted to the higher frequency side by setting the length of the notch portion 15 to a length shorter than one-quarter of the wavelength λ can be set to the lower frequency and whereby, the isolation frequency can be adjusted so as to be equal to the operating frequency of the antenna apparatus 10. Namely, even when the length of the notch portion 15 is shorter than or equal to one-quarter of the wavelength λ, the impedance of the open end can be made high at the operating frequency of the antenna apparatus 10 and whereby, the desired isolation between the antennas can be obtained.

At this time, the value of the capacitance generated by the stub 18 is determined based on the length L of the stub 18. Further, the value of the capacitance generated by the stub 18 is little affected by the thickness of the dielectric substrate and the relative permittivity of the dielectric.

Further, the conductor pattern for forming the stub 18 can be realized by a conventional printed wiring board manufacturing process. Therefore, the variation of the length of the stub 18 can be reduced to a very small level. Namely, the variation of the capacitance generated by the stub 18 can be reduced and the isolation frequency of the antenna apparatus 10 can be realized with a high degree of accuracy.

[Explanation of Operation]

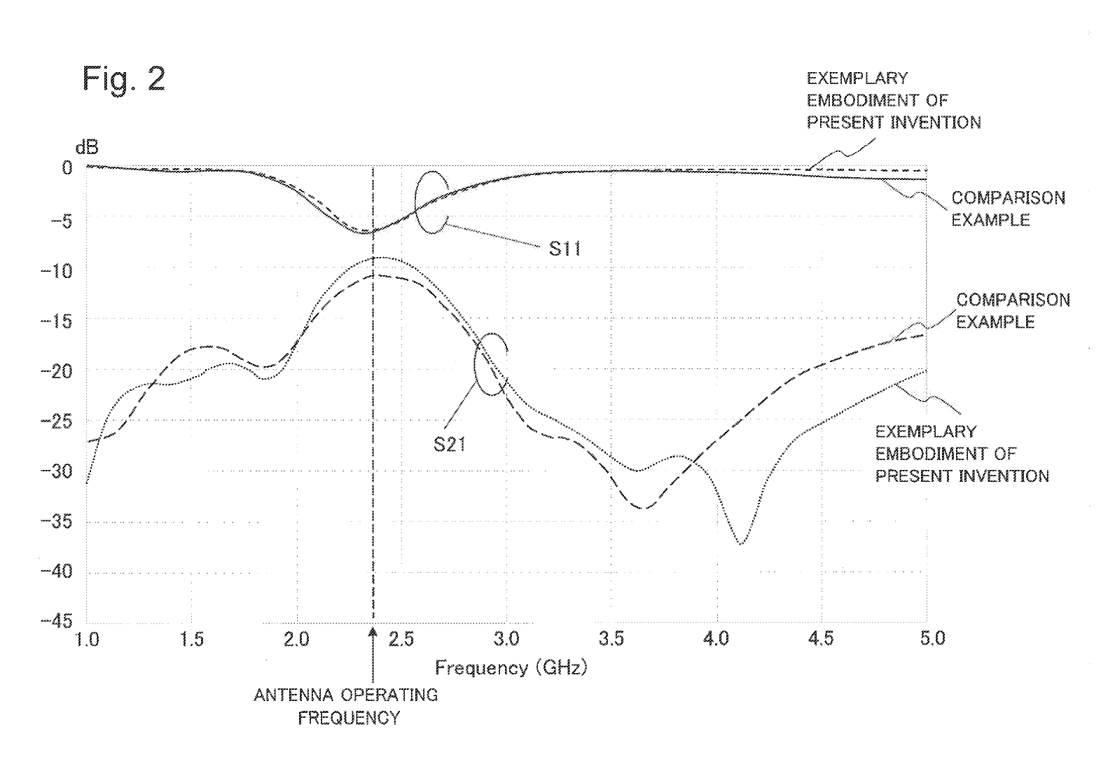

FIG. 2 shows a result of simulation of an antenna impedance characteristic of the antenna apparatus 10 according to the first exemplary embodiment of the present invention.

The result of simulation will be described below with reference to FIG. 2. Further, FIG. 2 shows the result of simulation with respect to the S11 and the S21 among S-parameters. Further, the S-parameters can be measured by a network analyzer. The S11 is a parameter related to a reflection coefficient or impedance matching. Further, the S21 is a parameter related to coupling or isolation.

With respect to the antenna apparatus according to the exemplary embodiment in which the length of the notch portion is 4 mm and the open stub is provided at the open end of the notch portion, the calculation result of the impedance characteristic between two antennas is shown.

For a comparison purpose, the calculation result of the impedance characteristic of the antenna apparatus in which the length of the notch portion is 9 mm and a conventional low coupling structure in which the stub is not provided is used is shown.

By comparing both characteristics, it is understood that S21 which represents a coupling factor between the antennas are approximately equal to each other at the antenna operating frequency (about 2.4 GHz). Further, it is understood that the S11 are approximately equal to each other.

Namely, in the antenna apparatus according to the exemplary embodiment, even when the length of the notch portion is short, the coupling factor between the antennas of the antenna apparatus according to the exemplary embodiment is approximately equal to that of the antenna apparatus in which the stub is not provided. Thus, because the length of the notch portion in the antenna apparatus according to the exemplary embodiment of the present invention can be shortened compared to the antenna apparatus having a conventional low coupling structure, the size of the antenna apparatus according to the exemplary embodiment can be reduced.

[Explanation of Effect]

As described above, by using the antenna apparatus according to the first exemplary embodiment of the present invention, a miniaturized low coupling structure which can reduce the electromagnetic coupling between two antennas can be obtained. Further, when a plurality of antennas are used, by forming the notch portion and the stub between the respective antennas like this exemplary embodiment, a similar effect can be obtained.

Namely, in the antenna apparatus according to the exemplary embodiment of the present invention, by providing the stub on the rear surface, an area required for arranging the stub can be increased. Therefore, because the added capacitance can be increased, it is not necessary to form a pattern width and perform positioning of the stub with a high degree of accuracy. For this reason, the stub can be easily manufactured by a conventional pattern process.

Further, in the antenna apparatus according to the exemplary embodiment, because the value of the added capacitance can be increased by the stub, the length of the notch portion can be reduced compared to the antenna apparatus in which the stub is not included. Further, by arranging the stub adjacent to the notch portion, the width of the notch portion can be made small. Therefore, the distance between the antennas can be reduced.

Namely, the size of the antenna apparatus according to the exemplary embodiment can be reduced compared to the antenna apparatus having a conventional low coupling structure.

### Second Exemplary Embodiment

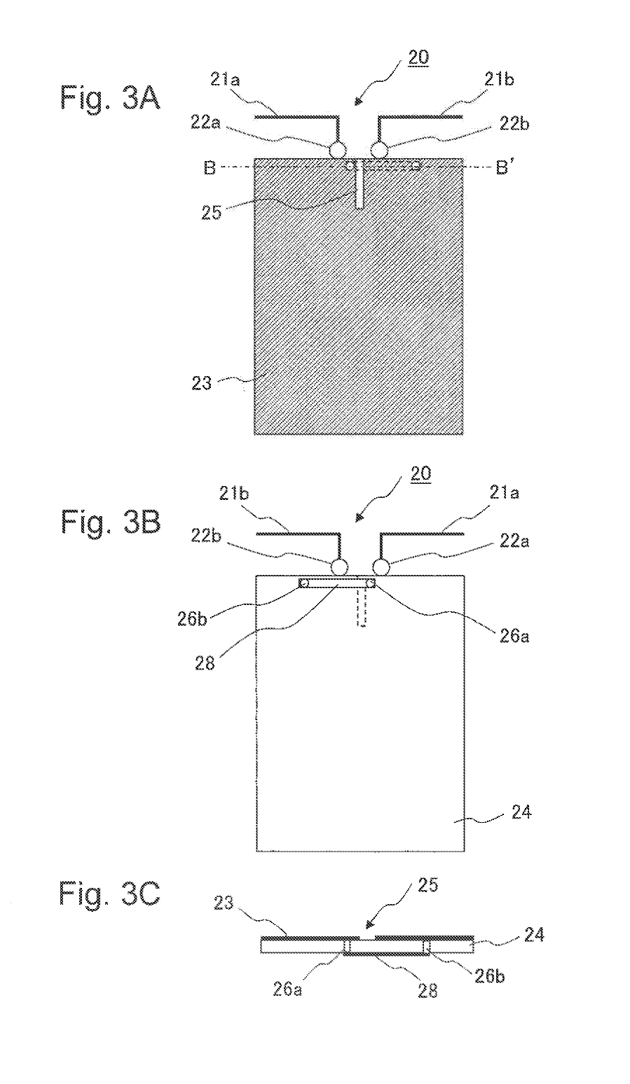

FIG. 3A to FIG. 3C are figures showing an antenna apparatus 20 according to a second exemplary embodiment of the present invention. Further, FIG. 3A shows a surface on which a conductor 23 mentioned later is arranged and FIG. 3B shows a surface on which a stub 28 mentioned later is arranged. FIG. 3C is a cross section along a line B-B′ shown in FIG. 3A.

[Explanation of Structure]

In the antenna apparatus 20 according to the second exemplary embodiment shown in FIG. 3A to FIG. 3C, the stub arranged at the open end of the notch portion is a short stub and the length L of the stub is set to satisfy λ/4<L<λ/2 (λ is a wavelength of the operating frequency). This is a difference between the structure of the antenna apparatus 20 according to the second exemplary embodiment and the structure of the antenna apparatus 10 according to the first exemplary embodiment.

The antenna apparatus 20 according to the second exemplary embodiment of the present invention includes a substrate 24 and the conductor 23 arranged on one of the surfaces of the substrate 24. Further, the substrate 24 and the conductor 23 are configured so as to be the same as those of the first exemplary embodiment.

Two antennas 21a and 21b are arranged on the substrate 24. In a connection portion for connecting the antennas 21a and 21b and the substrate 24, feeding portions 22a and 22b having a feed point are provided. Further, the shapes of the feeding portion 22a and the feeding portion 22b and the like are not limited in particular. The antenna shape and the like are configured so as to be the same as those of the first exemplary embodiment.

On the conductor 23, a notch portion 25 having the open end is provided at the end of the conductor 23. The notch portion 25 is configured so as to be the same as that of the first exemplary embodiment.

The stub 28 is arranged on the surface opposite to the surface of substrate 24 on which the notch portion 25 is arranged. The stub 28 according to the second exemplary embodiment is the short stub.

The stub 28 is arranged so as to cross over the notch portion 25. The stub 28 is arranged adjacent to the open end of the notch portion 25. The length L of the stub 28 is set to satisfy λ/4<L<λ/2. Further, the arrangement of the stub is the same as that of the first exemplary embodiment.

The stub 28 is electrically connected to the conductor 23 by vias 26a and 26b that are through-holes formed in the substrate 24 and have electrical conductivity.

[Explanation of Operation and Effect]

When the length of the notch portion 25 is set to a length shorter than one-quarter of the wavelength λ in order to reduce the size of the notch portion 25, a frequency at which an impedance of the open end of the notch portion 25 becomes high shifts higher than the operating frequency of the antenna apparatus 20. On the other hand, at the operating frequency of the antenna apparatus 20, the impedance of the open end of the notch portion 25 becomes inductive and low. Whereby, the antenna current flows. Therefore, the desired isolation between the antennas cannot be achieved.

As means for making the impedance of the open end high, a method in which a capacitance is added in parallel to the open end and a capacitance value is adjusted so as to generate parallel resonance in the operating frequency band of antenna is used. In the antenna apparatus according to the exemplary embodiment of the present invention, the stub 28 is provided at the open end of the notch portion 25 and the capacitance value is adjusted by tuning the length of the stub 28.

In the antenna apparatus 20 according to the second exemplary embodiment shown in FIG. 3A to FIG. 3C, the length L of the stub 28 arranged at the open end of the notch portion 25 is set to satisfy λ/4<L<λ/2 (λ is a wavelength of the operating frequency). This is equivalent to the addition of capacitance to the open end of the notch portion 25. As a result, the isolation frequency of the antenna apparatus 20 shifts to the lower frequency side. Namely, even when the length of the notch portion is shorter than or equal to one-quarter of the wavelength λ, the impedance of the open end is high at the operating frequency of the antenna apparatus 20 and whereby, the desired isolation between the antennas can be obtained.

At this time, the value of the capacitance generated by the stub 28 is determined based on the length L of the stub and little affected by the thickness of the dielectric substrate and the relative permittivity of the dielectric.

Further, the conductor pattern for forming the stub 28 can be realized by a conventional printed wiring board manufacturing process. Therefore, the variation of the length of the stub 28 can be reduced to a very small level. Namely, the variation of the capacitance generated by the stub 28 can be reduced and the isolation frequency of the antenna apparatus 20 can be realized with a high degree of accuracy.

As described above, by using the antenna apparatus according to the second exemplary embodiment of the present invention, a low coupling structure which can reduce the electromagnetic coupling between a plurality of antennas can be obtained like the first exemplary embodiment. Therefore, the size of the antenna apparatus according to this exemplary embodiment can be reduced compared to the antenna apparatus having a conventional low coupling structure.

### Third Exemplary Embodiment

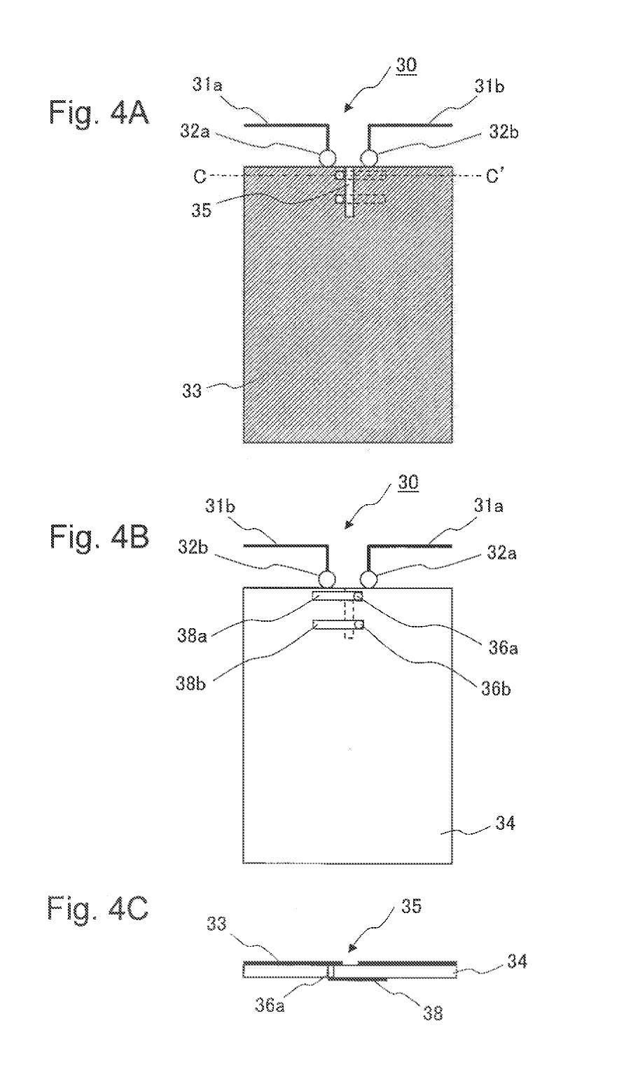

FIG. 4A to FIG. 4C are figures showing an antenna apparatus 30 according to a third exemplary embodiment of the present invention. Further, FIG. 4A shows a surface on which a conductor 33 mentioned later is arranged and FIG. 4B shows a surface on which a stub mentioned later is arranged. FIG. 4C is a cross section along a line C-C′ shown in FIG. 4A.

In the antenna apparatus 30 according to the third exemplary embodiment shown in FIG. 4A to FIG. 4C, a second stub that is the open stub is provided in addition to a first stub that is the open stub provided at the open end of the notch portion. This is a difference between the structure of the antenna apparatus 30 according to the third exemplary embodiment and the structure of the antenna apparatus 10 according to the first exemplary embodiment.

The antenna apparatus 30 according to the third exemplary embodiment of the present invention includes a substrate 34 and the conductor 33 arranged on one of the surfaces of the substrate 34. Further, the substrate 34 and the conductor 33 are configured so as to be the same as those of the first exemplary embodiment.

Two antennas 31a and 31b are arranged on the substrate 34. The antenna shape and the like are configured so as to be the same as those of the first exemplary embodiment. Further, when the antenna length is equal to a length of m/4 of the wavelength (m is odd number), two antennas 31a and 31b resonate at the frequencies corresponding to m/4 of the wavelength and operate as an antenna.

In a connection portion for connecting the antennas 31a and 31b and the substrate 34, feeding portions 32a and 32b having a feed point are provided. Further, the shapes of the feeding portion 32a and the feeding portion 32b and the like are not limited in particular.

On the conductor 33, the notch portion 35 having the open end is provided at the end of the conductor 33. The notch portion 35 is configured so as to be the same as that of the first exemplary embodiment.

A first stub 38a and a second stub 38b are arranged on the surface opposite to the surface of substrate 34 on which the notch portion 35 is arranged. The first and second stubs 38a and 38b according to the third exemplary embodiment are the open stubs like the first exemplary embodiment.

The first and second stubs 38a and 38b are arranged so as to cross over the notch portion 35. The first stub 38a is arranged adjacent to the open end of the notch portion 35. When the length of each of the antennas 31a and 31b is equal to a length of 3/4 of a wavelength λ′, the second stub 38b is arranged at a position a distance of 1/2 of the wavelength λ′ away from the open end of the cutout 35. The length L of each of the first and second stubs 38a and 38b is set to satisfy L<λ/4. Further, the stub is arranged so as to cross over the notch portion like the first exemplary embodiment.

The first stub 38a is electrically connected to the conductor 33 by a first via 36a that is a through-hole formed in the substrate 34 and has electrical conductivity. Similarly, the second stub 38b is electrically connected to the conductor 33 by a second via 36b. Further, the via is formed near the between the both end portions of the stub that is close to the open end of the notch portion among the end portions of the stub.

When the lengths of the antennas 31a and 31b are equal to the lengths of m/4 (m=1 and m=3) of the wavelength, respectively and the antennas 31a and 31b operate at the frequencies corresponding to m/4 of the wavelength, a structure which can reduce the coupling between the antennas 31a and 31b at the respective operating frequencies needs to be used.

The electric field of the notch portion 35 at the lower side antenna operating frequency has the standing wave distribution in which an antinode of the electric field is generated at the open end of the notch portion 35 and a node thereof is generated at a short-circuited end.

On the other hand, in the distribution of the electric field of the notch portion 35 at the higher side antenna operating frequency, an antinode of the electric field is generated at the open end of the notch portion 35 and a position a distance of 1/2 of the wavelength λ′ away from the open end of the notch portion 35. Therefore, the electric field of the notch portion 35 at the higher side antenna operating frequency has the standing wave distribution in which the nodes of the electric field are generated at a position a distance of 1/4 of the wavelength λ′ away from the open end of the notch portion 35 and a position a distance of 3/4 of the wavelength λ′ away from the open end of the notch portion 35.

Here, in the antenna apparatus 30 of the third exemplary embodiment, the first and second stubs 38a and 38b are arranged at the open end of the notch portion 35 and the position a distance of 1/2 of the wavelength λ′ away from the open end of the notch portion 35 at which the antinodes of the standing wave distribution are generated, respectively.

By adjusting the length of the first stub 38a arranged at the open end, both the lower side antenna operating frequency and the higher side antenna operating frequency change. In contrast, only the higher side antenna operating frequency changes by adjusting the length of the second stub 38b.

Accordingly, in order to realize the low coupling between the antennas 31a and 31b according to the third exemplary embodiment, the frequency is adjusted as follows.

First, by controlling the length of the first stub 38a arranged at the open end of the notch portion 35, the lower side isolation frequency of the antenna apparatus 30 is set to the lower side antenna operating frequency. Next, by controlling the length of the second stub 38b arranged at the position a distance of 1/4 of the wavelength away from the open end of the notch portion 35, the higher side isolation frequency of the antenna apparatus 30 is set to the higher side antenna operating frequency.

By using the structure used for the third exemplary embodiment, the coupling between the antennas can be reduced at a plurality of frequencies without changing the number of the notch portions between the antennas (in other words, one is maintained) and the size of the notch portion. Therefore, the size of the antenna apparatus having a substantially low coupling structure can be reduced.

### Fourth Exemplary Embodiment

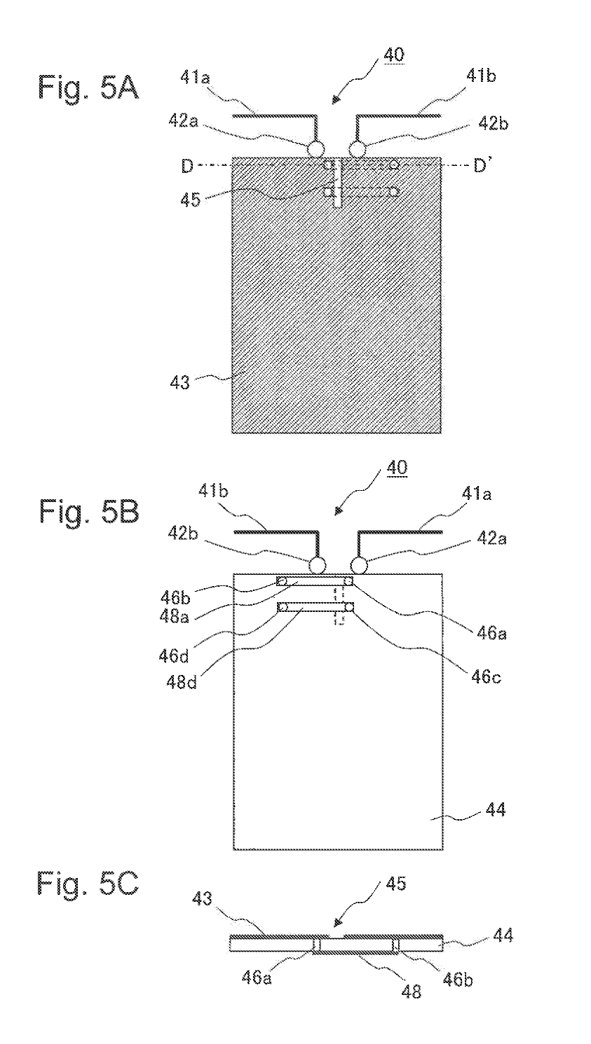

FIGS. 5A to 5C are figures showing an antenna apparatus 40 according to a fourth exemplary embodiment of the present invention. Further, FIG. 5A shows a surface on which a conductor 43 mentioned later is arranged and FIG. 5B shows a surface on which a stub mentioned later is arranged. FIG. 5C is a cross section along a line D-D′ shown in FIG. 5A.

In the antenna apparatus 40 according to the fourth exemplary embodiment shown in FIG. 5A to FIG. 5C, two stubs provided to the notch portion are the short stubs and the length L of each of the stubs is set to satisfy λ/4<L<λ/2 (λ is a wavelength of the operating frequency). This is a difference between the structure of the antenna apparatus 40 according to the fourth exemplary embodiment and the structure of the antenna apparatus 30 according to the third exemplary embodiment. Further, the stub is arranged so as to cross over the notch portion like the first exemplary embodiment.

The antenna apparatus 40 of the fourth exemplary embodiment of the present invention includes a substrate 44 and the conductor 43 arranged on one of the surfaces of the substrate 44. Further, the substrate 44 and the conductor 43 are configured so as to be the same as those of the first exemplary embodiment.

Two antennas 41a and 41b are arranged on the substrate 44. The antenna shape and the like are configured so as to be the same as those of the third exemplary embodiment. When the antenna length is equal to a length of m/4 of the wavelength (m is odd number), two antennas 41a and 41b resonate at the frequencies corresponding to m/4 of the wavelength and operate as an antenna.

In a connection portion for connecting the antennas 41a and 41b and the substrate 44, feeding portions 42a and 42b having a feed point are provided. Further, the shapes of the feeding portion 42a and the feeding portion 42b and the like are not limited in particular.

On the conductor 43, a notch portion 45 having the open end is provided at the end of the conductor 43. The notch portion 45 is configured so as to be the same as that of the first exemplary embodiment.

A first stub 48a and a second stub 48b are arranged on the surface opposite to the surface of substrate 44 on which the notch portion 45 is arranged. The first and second stubs 48a and 48b according to the fourth exemplary embodiment are the short stubs like the second exemplary embodiment.

The first and second stubs 48a and 48b are arranged so as to cross over the notch portion 45. The first stub 48a is arranged adjacent to the open end of the notch portion 45. The second stub 48b is arranged at a position a distance of 1/2 of the wavelength λ away from the open end of the notch portion 45. The length L of each of the first and second stubs 48a and 48b is set to satisfy λ/4<L<λ/2.

The first stub 48a is electrically connected to the conductor 43 by a first via 46a that is a through-hole formed in the substrate 44 and has electrical conductivity. Similarly, the second stub 48b is electrically connected to the conductor 43 by a second via 46b.

When the lengths of the antennas 41a and 41b are equal to the lengths of m/4 (m=1 and m=3) of the wavelength, respectively and the antennas 41a and 41b operate at the frequencies corresponding to m/4 of the wavelength, a structure which can reduce the coupling between the antennas 41a and 41b at the respective operating frequencies needs to be used.

The electric field of the notch portion 45 at the lower side antenna operating frequency has the standing wave distribution in which an antinode of the electric field is generated at the open end of the notch portion 45 and a node is generated at a short-circuited end.

On the other hand, in the distribution of the electric field of the notch portion 45 at the higher side antenna operating frequency, an antinode of the electric field is generated at the open end of the notch portion 45 and a position a distance of 1/2 of the wavelength λ away from the open end of the notch portion 45. Therefore, the electric field of the notch portion 45 at the higher side antenna operating frequency has the standing wave distribution in which the nodes of the electric field are generated at a position a distance of 1/4 of the wavelength away from the open end of the notch portion 45 and a position a distance of 3/4 of the wavelength away from the open end of the notch portion 45.

Here, in the antenna apparatus 40 according to the fourth exemplary embodiment, the first and second stubs 48a and 48b are arranged at the open end of the notch portion 45 and the position a distance of 1/2 of the wavelength λ away from the open end of the notch portion 45 at which the antinodes of the standing wave distribution are generated, respectively.

By adjusting the length of the first stub 48a arranged at the open end, the lower side antenna operating frequency and the higher side antenna operating frequency change. In contrast, only the higher side antenna operating frequency changes by adjusting the length of the second stub 48b.

Accordingly, in order to realize the low coupling between the antennas 41a and 41b according to the fourth exemplary embodiment, the frequency is adjusted as follows.

First, by controlling the length of the first stub 48a arranged at the open end of the notch portion 45, the lower side isolation frequency of the antenna apparatus 40 is set to the lower side antenna operating frequency. Next, by controlling the length of the second stub 48b arranged at the position a distance of 1/4 of the wavelength away from the open end of the notch portion 45, the higher side isolation frequency of the antenna apparatus 40 is set to the higher side antenna operating frequency.

By using the structure used for the fourth exemplary embodiment, the coupling between the antennas can be reduced at a plurality of frequencies without changing the number of the notch portions between the antennas (in other words, one is maintained) and the size of the notch portion like the third exemplary embodiment. Therefore, the size of the antenna apparatus can be substantially reduced.

Further, in the third and fourth exemplary embodiments, the mode in which two stubs are used has been explained. However, the number of the stubs used in the antenna apparatus according to the exemplary embodiment of the present invention is not limited to two. Three or more stubs may be used. When a plurality of stubs are arranged, each of the stubs is arranged at a position a distance of n/4 of the wavelength (n is an even number) of each of the operating frequencies of the antenna apparatus away from the open end of the notch portion.

### Fifth Exemplary Embodiment

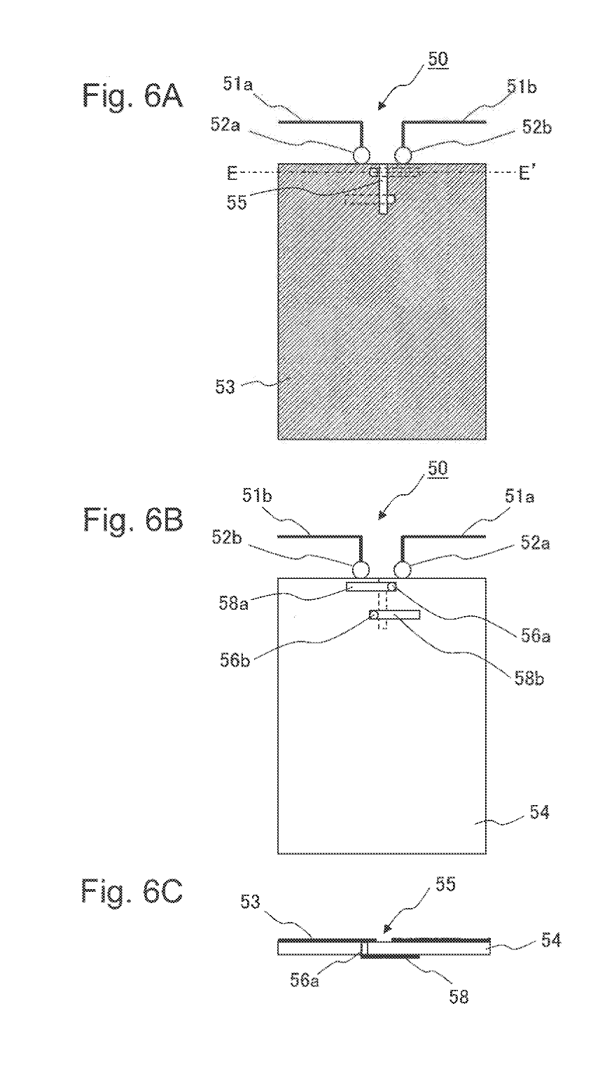

FIG. 6A to FIG. 6C are figures showing an antenna apparatus 50 according to a fifth exemplary embodiment of the present invention. Further, FIG. 6A shows a surface on which a conductor 53 mentioned later is arranged and FIG. 6B shows a surface on which a stub mentioned later is arranged. FIG. 6C is a cross section along a line E-E′ shown in FIG. 6A.

In the antenna apparatus 50 according to the fifth exemplary embodiment shown in FIG. 6A to 6C, two vias are arranged at the both sides of the notch portion and the stub is arranged so as to cross over the notch portion. This is a difference between the structure of the antenna apparatus 50 according to the fifth exemplary embodiment and the structure of the antenna apparatus 30 according to the third exemplary embodiment.

The antenna apparatus 50 according to the fifth exemplary embodiment of the present invention includes a substrate 54 and the conductor 53 arranged on one of the surfaces of the substrate 54. Further, the substrate 54 and the conductor 53 are configured so as to be the same as those of the first exemplary embodiment.

Two antennas 51a and 51b are arranged on the substrate 54. The antenna shape and the like are configured so as to be the same as those of the third exemplary embodiment. Further, when the antenna length is equal to a length of m/4 of the wavelength (m is odd number), two antennas 51a and 51b resonate at the frequencies corresponding to m/4 of the wavelength and operate as an antenna.

In a connection portion for connecting the antennas 51a and 51b and the substrate 54, feeding portions 52a and 52b having a feed point are provided. Further, the shapes of the feeding portion 52a and the feeding portion 52b and the like are not limited in particular.

On the conductor 53, a notch portion 55 having the open end is provided at the end of the conductor 53. The notch portion 55 is configured so as to be the same as that of the first exemplary embodiment.

A first stub 58a and a second stub 58b are arranged on the surface opposite to the surface of the substrate 54 on which the notch portion 55 is arranged. The first and second stubs 58a and 58b according to the fifth exemplary embodiment are the open stubs like the third exemplary embodiment. Further, the stub is arranged so as to cross over the notch portion like the first exemplary embodiment. Further, in the fifth exemplary embodiment, the stub may be the short stub.

The first and second stubs 58a and 58b are arranged so as to cross over the notch portion 55. The first stub 58a is arranged adjacent to the open end of the notch portion 55. The second stub 58b is arranged at a position a distance of 1/2 of the wavelength λ away from the open end of the notch portion 55. The length L of each of the first and second stubs 58a and 58b is set to satisfy L<λ/4. Further, when the first and second stubs 58a and 58b are the short stubs, the length L is set to satisfy λ/4<L<λ/2.

The first stub 58a is electrically connected to the conductor 53 by a first via 56a that is a through-hole formed in the substrate 54 and has electrical conductivity. Similarly, a second stub 58b is electrically connected to the conductor 53 by a second via 56b. Further, the via is formed near the between the both end portions of the stub that is close to the open end of the notch portion among the end portions of the stub.

In the fifth exemplary embodiment, the first via 56a and the second via 56b are arranged at the both sides of the notch portion 55.

The antenna apparatus 50 according to the fifth exemplary embodiment has operation and effect that are the same as those of the antenna apparatuses 30 and 40 according to the third and fourth exemplary embodiments.

Namely, even when a plurality of vias are arranged at the both sides of the notch portion as described in the fifth exemplary embodiment, the antenna apparatus 50 according to the fifth exemplary embodiment has operation and effect that are the same as those of the antenna apparatus 30 according to the third exemplary embodiment.

In the antenna apparatuses according to the first to fifth exemplary embodiments described above, the stub has an elongated shape. However, in the antenna apparatus of the present invention, the shape of the stub is arbitrary when the length L of the open stub satisfies L<λ/4. Further, when the short stub is used, the shape of the stub is arbitrary when the length L of the short stub satisfies λ/4<L<λ/2.

The antenna apparatus according to the exemplary embodiment which has a stub whose shape is not the elongated shape will be described below.

### Sixth Exemplary Embodiment

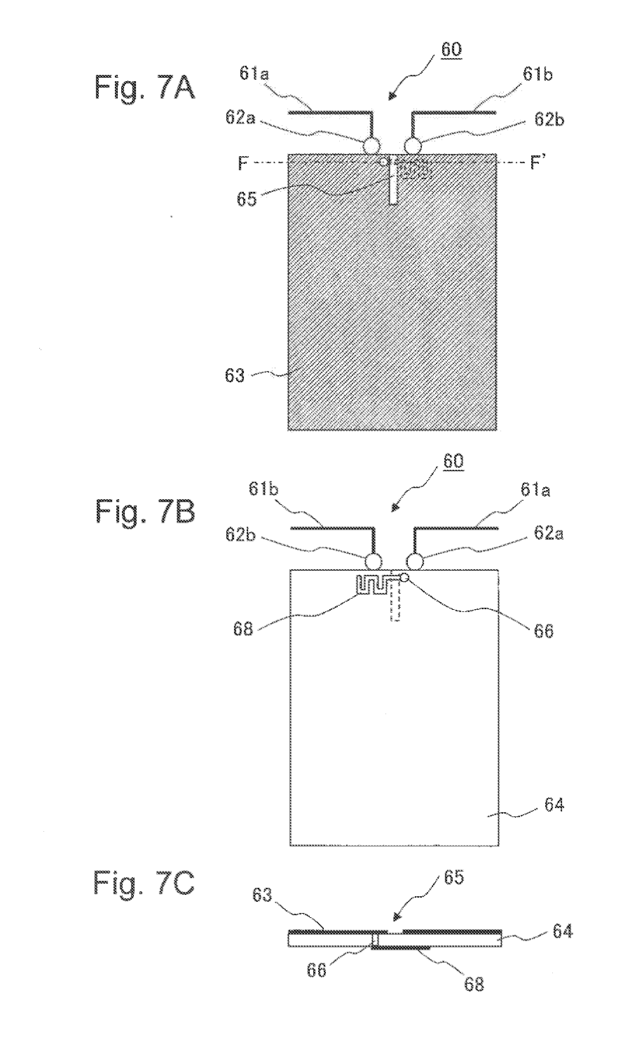

FIG. 7A to FIG. 7C are figures showing an antenna apparatus 60 according to a sixth exemplary embodiment of the present invention. Further, FIG. 7A shows a surface on which a conductor 63 mentioned later is arranged and FIG. 7B shows a surface on which a stub 68 mentioned later is arranged. FIG. 7C is a cross section along a line F-F′ shown in FIG. 7A.

In the antenna apparatus 60 according to the sixth exemplary embodiment shown in FIG. 7A to FIG. 7C, the shape of the stub arranged at the open end of the notch portion is a meandering shape. This is a difference between the structure of the antenna apparatus 60 according to the sixth exemplary embodiment and the structure of the antenna apparatus 10 according to the first exemplary embodiment.

The antenna apparatus 60 according to the sixth exemplary embodiment of the present invention includes a substrate 64 and the conductor 63 arranged on one of the surfaces of the substrate 64. Further, the substrate 64 and the conductor 63 are configured so as to be the same as those of the first exemplary embodiment.

Two antennas 61a and 61b are arranged on the substrate 64. The antenna shape and the like are configured so as to be the same as those of the first exemplary embodiment.

In a connection portion for connecting the antennas 61a and 61b and the substrate 64, feeding portions 62a and 62b having a feed point are provided. Further, the shapes of the feeding portion 62a and the feeding portion 62b and the like are not limited in particular.

On the conductor 63, the notch portion 65 having the open end is provided at the end of the conductor 63. The notch portion 65 is configured so as to be the same as that of the first exemplary embodiment.

The stub 68 is arranged on the surface opposite to the surface of substrate 64 on which the notch portion 65 is arranged. The stub 68 according to the sixth exemplary embodiment is the open stub. Further, the stub is arranged so as to cross over the notch portion like the first exemplary embodiment.

The stub 68 is arranged so as to cross over the notch portion 65. The stub 68 is arranged adjacent to the open end of the notch portion 65. The length L of the stub 68 is set to satisfy L<λ/4.

The stub 68 is electrically connected to the conductor 63 by a via 66 that is a through-hole formed in the substrate 64 and has electrical conductivity. Further, the via 66 is formed near the between the both end portions of the stub 68 that is close to the open end of the notch portion 65 among the end portions of the stub 68.

The antenna apparatus 60 according to the sixth exemplary embodiment has operation and effect that is the same as those of the antenna apparatus 10 according to the first exemplary embodiment.

Further, when the short stub is used for the stub 68, the entire length L of the stub is set to satisfy λ/4<L<λ/2 and another via may be provided near the end of the stub 68.

Namely, even when the shape of the stub is a meandering shape like the sixth exemplary embodiment, the antenna apparatus 60 according to the sixth exemplary embodiment has operation and effect that is the same as those of the antenna apparatus 10 according to the first exemplary embodiment.

### Seventh Exemplary Embodiment

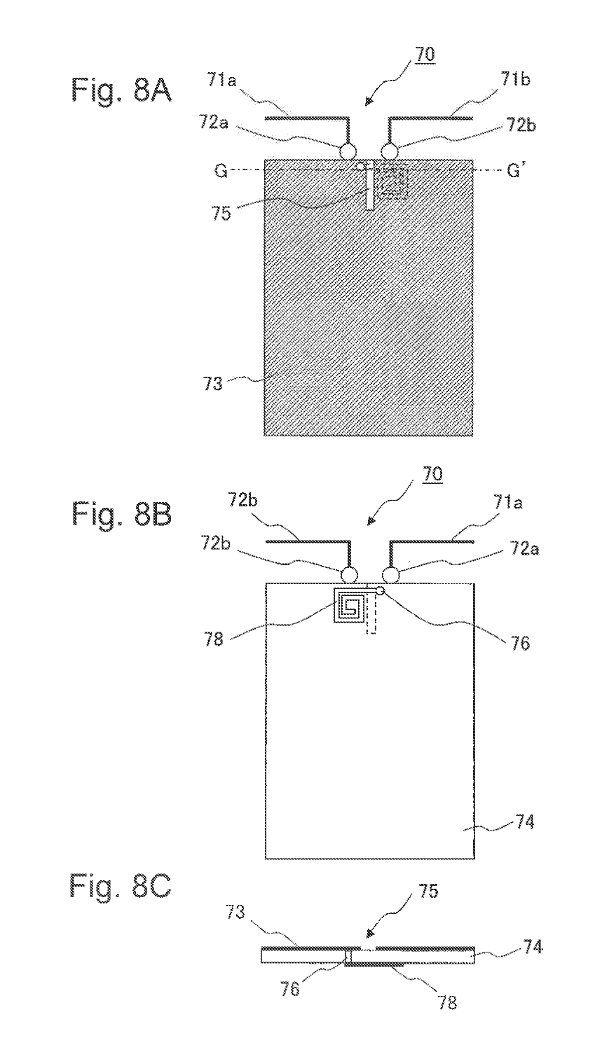

FIG. 8A to FIG. 8C are figures showing an antenna apparatus 70 according to a seventh exemplary embodiment of the present invention. Further, FIG. 8A shows a surface on which a conductor 73 mentioned later is arranged and FIG. 8B shows a surface on which a stub 78 mentioned later is arranged. FIG. 8C is a cross section along a line G-G′ shown in FIG. 8A.

In the antenna apparatus 70 according to the seventh exemplary embodiment shown in FIG. 8A to FIG. 8C, the shape of the stub arranged at the open end of the notch portion is a helical shape (a spiral shape). This is a difference between the structure of the antenna apparatus 70 according to the seventh exemplary embodiment and the structure of the antenna apparatus 10 according to the first exemplary embodiment.

The antenna apparatus 70 according to the seventh exemplary embodiment of the present invention includes a substrate 74 and the conductor 73 arranged on one of the surfaces of the substrate 74. Further, the substrate 74 and the conductor 73 are configured so as to be the same as those of the first exemplary embodiment.

Two antennas 71a and 71b are arranged on the substrate 74. The antenna shape and the like are configured so as to be the same as those of the first exemplary embodiment.

In a connection portion for connecting the antennas 71a and 71b and the substrate 74, feeding portions 72a and 72b having a feed point are provided. Further, the shapes of the feeding portion 72a and the feeding portion 72b and the like are not limited in particular.

On the conductor 73, a notch portion 75 having the open end is provided at the end of the conductor 73. The notch portion 75 is configured so as to be the same as that of the first exemplary embodiment.

The stub 78 is arranged on the surface opposite to the surface of substrate 74 on which the notch portion 75 is arranged. The stub 78 according to the seventh exemplary embodiment is the open stub.

The stub 78 is arranged so as to cross over the notch portion 75. The stub 78 is arranged adjacent to the open end of the notch portion 75. The length L of the stub 78 is set to satisfy L<λ/4.

The stub 78 is electrically connected to the conductor 73 by a via 76 that is a through-holes formed in the substrate 74 and has electrical conductivity. Further, the via 76 is formed near the between the both end portions of the stub 78 that is close to the open end of the notch portion 75 among the end portions of the stub 78.

The antenna apparatus 70 according to the seventh exemplary embodiment has operation and effect that is the same as those of the antenna apparatus 10 according to the first exemplary embodiment. Further, when the short stub is used for the stub 78, the entire length L of the stub is set to satisfy λ/4<L<λ/2 and another via may be provided near the end of the stub 78.

Namely, even when the shape of the stub is the helical shape (the spiral shape) like the seventh exemplary embodiment, the antenna apparatus 70 according to the seventh exemplary embodiment has operation and effect that is the same as those of the antenna apparatus 10 according to the first exemplary embodiment.

The shape of the stub can be changed to another shape other than the elongated shape like the sixth and seventh exemplary embodiments mentioned above. The shape of the stub used for the sixth and seventh exemplary embodiments has a regular pattern. However, for example, a random meandering pattern can be used instead of the regular pattern.

### Eighth Exemplary Embodiment

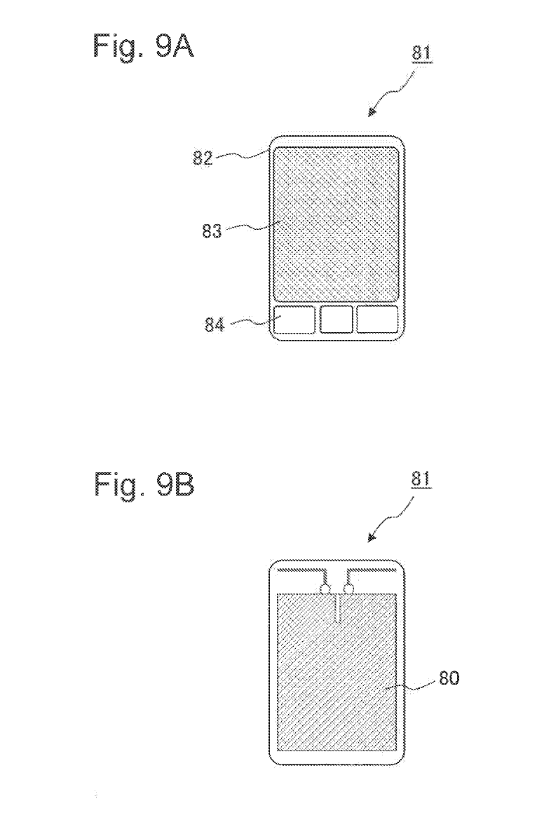

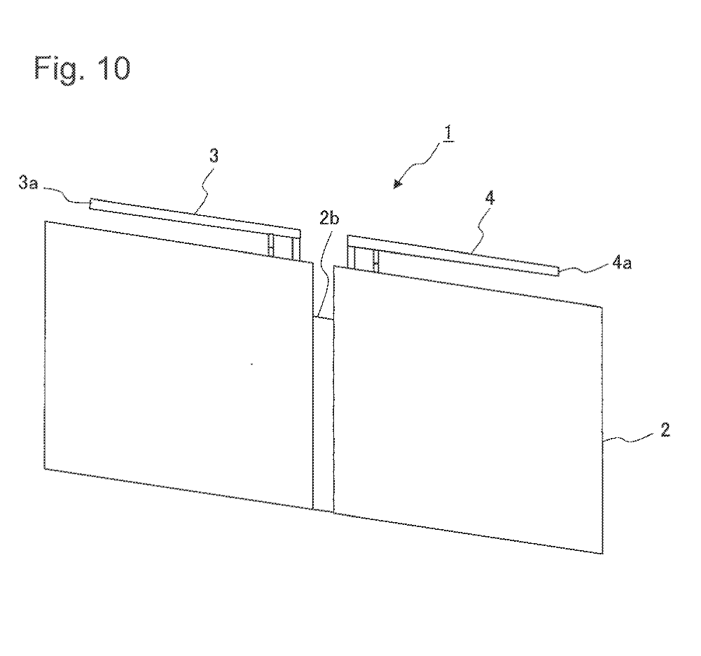

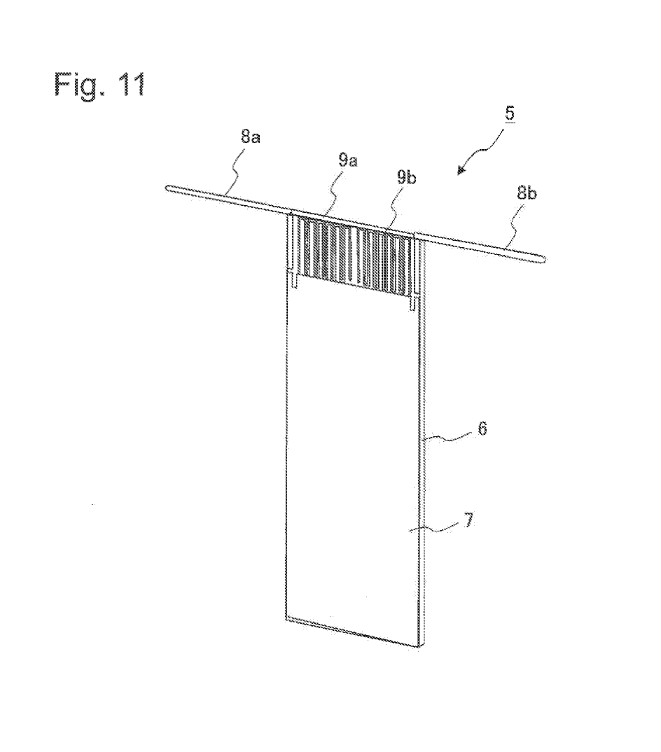

FIG. 9A is a figure showing a portable wireless device according to a ninth exemplary embodiment which mounts an antenna apparatus 80 according to the first to eighth exemplary embodiments of the present invention. FIG. 9B is a figure showing the portable wireless device according to the ninth exemplary embodiment when viewed from a surface side opposite to the surface side shown in FIG. 9A.

A portable wireless device 81 according to the eighth exemplary embodiment shown in FIG. 9A and FIG. 9B includes a chassis 82, a display unit 83, and an input unit 84. The antenna apparatus 80 is included in the portable wireless device 81. Further, the antenna apparatus 80 may be the antenna apparatus according to the exemplary embodiment of the present invention. The display unit 83 and the input unit 84 can be removed according to the need.

The portable wireless device 81 according to the exemplary embodiment includes the antenna apparatus 80 inside the chassis 82. Further, FIG. 9B is a perspective view for showing the antenna apparatus 80 that is arranged inside the chassis 82. However, the antenna apparatus 80 may be arranged on an outside surface of the chassis 82. Further, only the antenna of the antenna apparatus 80 may be provided outside the chassis 82.

The portable wireless device 81 according to the exemplary embodiment includes a transmission and reception circuit (not shown) and a control circuit (not shown). Therefore, it can transmit and receive a radio wave via the antenna.

In the portable wireless device 81 according to the exemplary embodiment, the size of the notch portion can be reduced compared to the size of the ground pattern, the variation of the capacitance generated by the stub can be suppressed, and the isolation frequency of the antenna apparatus 80 can be realized with a high degree of accuracy. Therefore, the reliability of the portable wireless device 81 becomes high. Because the stub can be formed as a conductor pattern, the portable wireless device 81 is suitable for transmitting and receiving the radio wave in a plurality of frequency bands.

Further, the portable wireless device according to the exemplary embodiment is not limited to the exemplary embodiment shown in FIG. 9A and FIG. 9B and can be applied to a small-size wireless apparatus such as a wireless LAN card used for a notebook computer, a transmission and reception apparatus for an environment sensor device or the like, or the like. Namely, the portable wireless device according to the exemplary embodiment can be applied to the small-size wireless apparatus but the application of the portable wireless device according to the exemplary embodiment is not limited to the use of the portable device carried at all times.

As described above, in the antenna apparatus according to the exemplary embodiment of the present invention, the capacitance is added by using the stub and the size of the notch portion can be reduced. Whereby, the low coupling structure and the small-size antenna apparatus can be realized. The value of the capacitance added by the stub can be controlled by the length of the stub. Therefore, the influence due to the variation of the thickness and the relative permittivity of the substrate (the dielectric substrate) on the isolation frequency of the antenna apparatus having the low coupling structure can be reduced.

It is not necessary to use a chip capacitor in order to reduce the size of the antenna apparatus. Therefore, the number of components to be used can be reduced and the cost reduction can be achieved.

A conventional printed wiring board manufacturing process can be used for the antenna apparatus of the present invention. Therefore, the stub can be manufactured with a high degree of accuracy and the desired isolation frequency can be realized with a high degree of accuracy within a very small variation range.

By using a plurality of stubs and arranging them at the appropriate positions, multiple resonances can be realized by one notch portion and whereby, the size of the antenna can be substantially reduced. By controlling the length of each stub, a plurality of isolation frequencies can be independently adjusted. Therefore, the antenna apparatus having the low coupling structure can be easily designed.

Namely, in the antenna apparatus of the present invention, even when the size of the notch portion is reduced, an area in which the stub is arranged can be increased and whereby, a high capacitance can be added. Therefore, the size of the antenna apparatus can be reduced. Because a coupling factor between a plurality of antennas can be reduced without reducing the width of the stub, the variation of the isolation characteristic can be suppressed to a small level and the antenna apparatus having a fixed antenna coupling factor can be realized.

A part of or all of each exemplary embodiment mentioned above can be described as the following supplementary note. However, the present invention is not limited to the following supplementary note.

(Supplementary Note 1)

An antenna apparatus characterized by comprising

a substrate,

a conductor arranged on one of the surfaces of the substrate,

a plurality of antennas arranged on the substrate,

a notch portion formed to the conductor so as to have an open end between the plurality of antennas,

a stub formed on the other surface of the substrate so as to cross over the notch portion, and

a via for electrically connecting the conductor and the stub.

(Supplementary Note 2)

The antenna apparatus described in Supplementary note 1 characterized in that the length of the notch portion is shorter than a length of one-quarter of the wavelength of the lowest frequency among resonant frequencies of the antenna.

(Supplementary Note 3)

The antenna apparatus described in Supplementary note 1 or Supplementary note 2 characterized in that the stub is arranged at the open end of the notch portion.

(Supplementary Note 4)

The antenna apparatus described in any one of Supplementary notes 1 to 3 characterized in that the stub is an open stub.

(Supplementary Note 5)

The antenna apparatus described in Supplementary note 4 characterized in that the length of the stub is shorter than a length of one-quarter of the wavelength of an operating frequency of the antenna apparatus.

(Supplementary Note 6)

The antenna apparatus described in any one of Supplementary notes 1 to 3 characterized in that the stub is a short stub.

(Supplementary Note 7)

The antenna apparatus described in Supplementary note 6 characterized in that the length of the stub is longer than a length of one-quarter of the wavelength of the resonant frequency of the antenna and shorter than a length of one-half of the wavelength of the resonant frequency of the antenna.

(Supplementary Note 8)

The antenna apparatus described in any one of Supplementary notes 1 to 7 characterized in that a plurality of the stubs that correspond to a plurality of resonant frequencies of the antenna are arranged.

(Supplementary Note 9)

The antenna apparatus described in Supplementary note 8 characterized in that each of a plurality of the stubs is arranged at a position a distance of an even multiple of one quarter of the wavelength of each of the plurality of resonant frequencies of the antenna away from the open end of the notch portion.

(Supplementary Note 10)

The antenna apparatus described in Supplementary notes 1 to 9 characterized in that a shape of the stub is an elongated shape.

(Supplementary Note 11)

The antenna apparatus described in any one of Supplementary notes 1 to 9 characterized in that a shape of the stub is a meandering shape.

(Supplementary Note 12)

The antenna apparatus described in any one of Supplementary notes 1 to 9 characterized in that a shape of the stub is a helical shape.

(Supplementary Note 13)

The antenna apparatus described in any one of Supplementary notes 1 to 12 characterized in that the antenna device includes three or more antennas.

(Supplementary Note 14)

A wireless apparatus equipped with the antenna apparatus described in any one of Supplementary notes 1 to 13.

The invention of the present application has been described above with reference to the exemplary embodiment and the example. However, the invention of the present application is not limited to the above mentioned exemplary embodiment and example. Various changes in the configuration or details of the invention of the present application that can be understood by those skilled in the art can be made without departing from the scope of the invention. For example, when those skilled in the art read a description of the above-mentioned exemplary embodiments and examples, they can easily conceive a lot of modifications or replacements by using a component or a technology equivalent to that of these exemplary embodiment and example. However, these modification and replacement are included in the scope of the invention of the present application.

This application claims priority based on Japanese Patent Application No. 2012-73664 filed on Mar. 28, 2012, the disclosure of which is hereby incorporated by reference in its entirety.

### DESCRIPTION OF SYMBOL

1 integrally formed flat-plate multi-element antenna

2 ground pattern

2b notch portion

3 first radiating element

4 second radiating element

5 antenna apparatus

6 substrate

7 copper layer

8a first antenna element

8b second antenna element

9a first stub

9b second stub

10 antenna apparatus

11a and 11b antenna

12a and 12b feeding portion

13 conductor

14 substrate

15 notch portion

16 via

18 stub

30 antenna apparatus

31a and 31b antenna

33 conductor

34 substrate

35 notch portion

36a first via

36b second via

38a first stub

38b second stub

80 antenna apparatus

81 portable wireless device

82 chassis

83 display unit

84 input unit

1. An antenna apparatus comprising:
a substrate,
a conductor arranged on one of the surfaces of the substrate,
a plurality of antennas arranged on the substrate,
a notch portion formed to the conductor so as to have an open end between a plurality of the antennas,
a stub formed on the other surface of the substrate so as to cross over the notch portion, and
a via for electrically connecting the conductor and the stub.

2. The antenna apparatus described in claim 1 wherein the length of the notch portion is shorter than a length of one-quarter of the wavelength of the lowest frequency among resonant frequencies of the antenna.

3. The antenna apparatus described in claim 1 wherein the stub is arranged at the open end of the notch portion.

4. The antenna apparatus described in claim 1 wherein the stub is an open stub.

5. The antenna apparatus described in claim 4 wherein the length of the stub is shorter than a length of one-quarter of the wavelength of the resonant frequency of the antenna apparatus.

6. The antenna apparatus described in claim 1 wherein the stub is a short stub.

7. The antenna apparatus described in claim 6 wherein the length of the stub is longer than a length of one-quarter of the wavelength of the resonant frequency of the antenna and shorter than a length of one-half of the wavelength of the resonant frequency of the antenna.

8. The antenna apparatus described in claim 1 wherein a plurality of the stubs that correspond to a plurality of resonant frequencies of the antenna are arranged.

9. The antenna apparatus described in claim 8 wherein each of a plurality of the stubs is arranged at a position a distance of an even multiple of one quarter of the wavelength of each of the plurality of resonant frequencies of the antenna away from the open end of the notch portion.

10. A wireless apparatus equipped with the antenna apparatus described in claim 1.
